(19) United States
(12) Patent Application Publication
(10) Pub. No.: US 2008/0232318 A1
(43) Pub. Date: Sep. 25, 2008

(54) METHOD AND APPARATUS OF INTRODUCING XID FRAMES FOR LAPDm PROCEDURE

(75) Inventor: Behrouz Aghili, Melville, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/054,014

(22) Filed: Mar. 24, 2008

Related U.S. Application Data
(60) Provisional application No. 60/896,518, filed on Mar. 23, 2007.

(51) Int. Cl. H04Q 7/00

(52) U.S. Cl. 370/329

(57) ABSTRACT

A method and apparatus for introducing exchange information (XID) frames for link access Procedure on the Dm (data) channel (LAPDm) Procedure comprises commencing a negotiation between a mobile station (MS) and a basic service set (BSS). XID frames are transmitted between the MS and the BSS.

### CROSS REFERENCE TO RELATED APPLICATIONS

This application claims the benefit of U.S. provisional application No. 60/896,518 and having a filing date of Mar. 23, 2007, which is incorporated by reference as if fully set forth.

### FIELD OF INVENTION

This application relates to the field of wireless communications.

### BACKGROUND

Transmissions in the Global System for Mobile Communication (GSM) system have been divided into frames. FIG. 1 illustrates a frame, generally known as LAPDm frame (Link Access Procedures for the Dm channel), to be transmitted at a radio interface, which has generally been divided into four fields. The first field is an address field ADD, which contains the address of the destination of the message, given in one byte. In the GSM system, almost all signaling messages are also transmitted within corresponding LAPDm frames.

In wireless communications, two message flows can simultaneously exist independent of each other: signaling messages and short messages. These two different flows are separated from each other by a link identifier, a so-called SAPI (Service Access Point Identifier) to be added to the address field ADD. Its value can be 0, indicating signaling, or 3, indicating a short message. The second field is a control field CTRL, which contains the type of frame being sent and, in most of the cases, the sending frame and receiving frame numbers N(S) and N(R). The third field is a Length Indicator (LI) and the fourth field is a data field INFO, containing the actual information, (i.e., the contents of the actual message).

In recent wireless communication systems like Enhanced Data rates for GSM Evolution (GSM/EDGE) or Universal Mobile Telecommunications System (UMTS), some signaling messages cannot be contained in one single frame and, therefore have to be segmented in several frames. The transmission of the complete signaling message with the highest priority results in the transmission of data packets belonging to other data flows with lower priority being stopped until the signaling message has been correctly transmitted. If the other data flows are carrying real-time data, the long interruption of transmission for this data flow results in either irrecoverable delay or long muting in real-time data packet transmission.

This problem is automatically solved in GSM using LAPDm as its layer 2 communication Procedure for the signaling plane. This Procedure enables only the transmission of a further data packet when an acknowledgement for the preceding packet has been received at the transmitter. Since the transmit window size is limited to one, the delay between the transmission of two high priority data packets is at least equal to one round trip delay, which is the minimum time required for the transmitter to send a data packet and receive its acknowledgement from the receiving entity. During this time, data packets belonging to traffic data flows with lower priority can be transmitted, reducing to the minimum either the delay in real-time data packets transmission or the pre-emption duration. In this solution, the total time required for transmitting a signaling message segmented in several data packets is very long.

As mentioned, the current design of the LAPDm Procedure only allows for window size of one. So far, the need for extending the window has not been evident as almost all Layer 3 messages could fit in one LAPDm frame. Today, the Adaptive Multi-Rate (AMR) parameters, together with the Frequency Hopping information, result in situations where higher layer messages, specifically the “Handover Command” and the “Assignment Command”, normally call for segmentation into two LAPDm frames.

In the current version of the LAPDm protocol, there exist three formats of Frames for the exchange of information. These formats are called “Information (I-Frames)”, “Supervisory (S-Frame)” and “Unnumbered (U-Frames)”. The I-Frames and S-Frames are always sent in Acknowledged Mode whereas the U-Frames are sent in Unacknowledged Mode. The U-Frames may carry information from higher layers and are also used in order for the Procedure entities to start/stop Acknowledged Mode. So far, there has not existed a possibility, for the LAPDm entities, to negotiate protocol parameters.

As these messages are normally sent in case of either intra-cell or inter-cell handover, the possibility of dropping the call is fairly high since the uplink (UL) is normally the weakest link. The reason is that the Base Station System (BSS) cannot send the second segment of the message before receiving an acknowledgement from the Wireless Transmit/Receive Unit (WTRU) or the Mobile Station (MS).

In the current implementation of GSM, the LAPDm link for service access point identifier (SAPI)=0 is established between the mobile station (MS) and the BSS, for the Fast Associated Control Channel (FACCH), by the exchange of two messages: (1) Set Asynchronous Balanced Mode (SABM); and (2) Unnumbered Acknowledge (UA). Once this link is established, all L3 messages, on FACCH, are sent in Acknowledged Mode. The window size, as mentioned above, has been fixed at one, hence restricting flexibility at the transmitting side. This results in scenarios where the transmitter cannot deliver the other segments of a message while waiting for an acknowledgement from the receiver.

It would therefore be advantageous for a method and apparatus to be provided that introduces eXchange IDentification (XID) frames for the LAPDm protocol.

### SUMMARY

A method and apparatus directed to the modification of Data Link Layer Procedure for signaling (the LAPDm Protocol), in order to avoid problems related to dropped calls that have been observed by the operators in various networks.

### BRIEF DESCRIPTION OF THE DRAWING

A more detailed understanding of the application may be achieved from the following description of a preferred embodiment, given by way of example and to be understood in conjunction with the accompanying drawing wherein:

FIG. 1 is an example of prior art link access procedure on the Dm (data) channel (LAPDm) frame.

FIG. 2 is a schematic illustration of a part of a mobile network implementing the present method.

FIG. 3 is an exemplary signal diagram showing a link establishment and parameter negotiation between a Wireless Transmit/Receive Unit (WTRU) and a Base Station System (BSS).

FIG. 4 is a functional block diagram of a base station system and a Wireless Transmit/Receive Unit (WTRU).

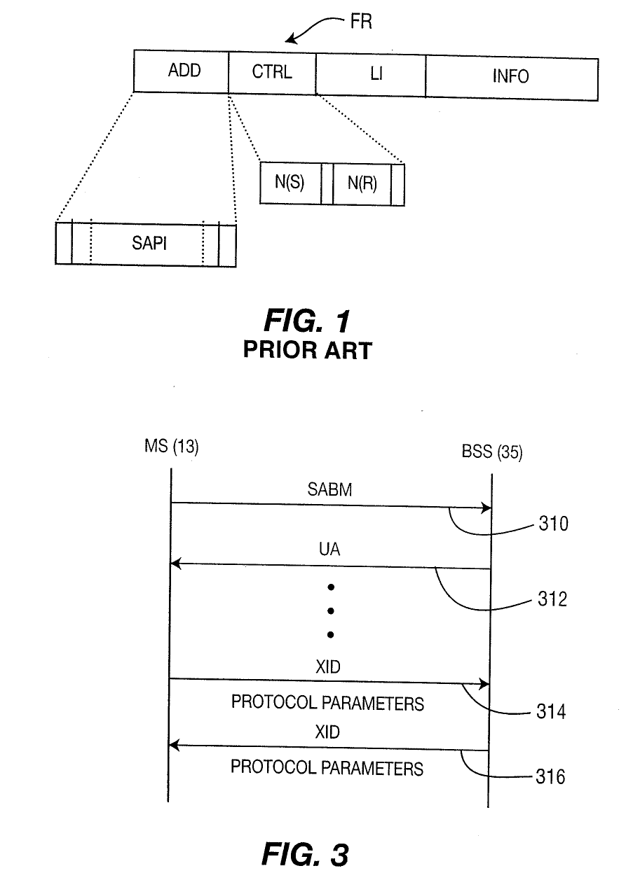

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The present method is directed toward introducing a modification to the LAPDm Protocol. Data link layer protocols that are similar use the capability of negotiating Procedure parameters between the peers. Accordingly, a negotiation process is provided between the Wireless Transmit/Receive Unit (WTRU)/mobile station (MS) and Base Station System (BSS) by introducing an eXchange IDentification (XID) Frame.

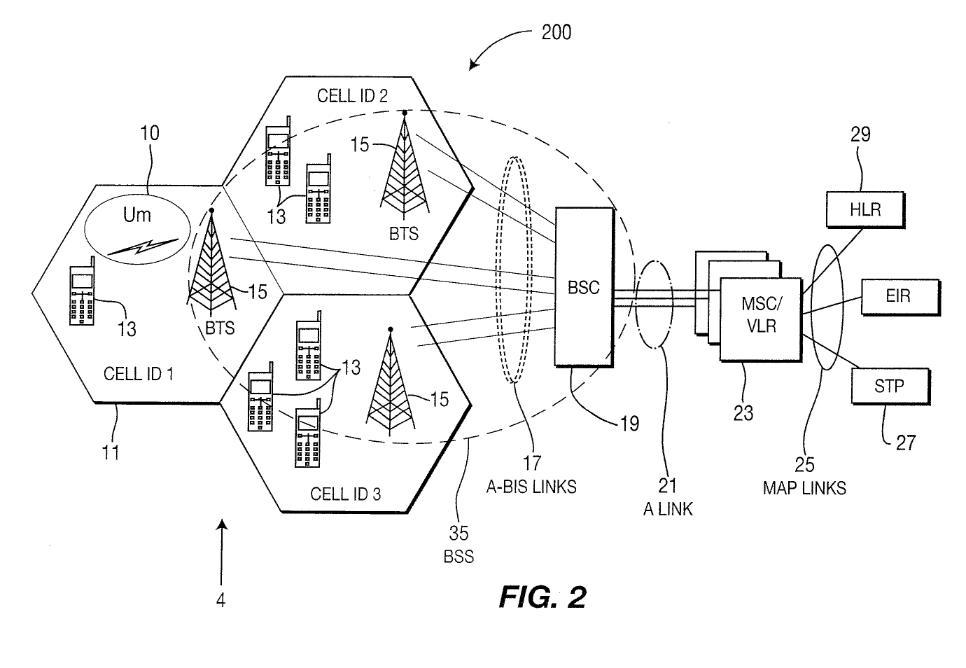

FIG. 2 depicts major elements of a GSM cellular mobile telephone network 200. In the figure, only the signaling links which are of interest in the context of this method are shown and other signals are omitted.

Referring to FIG. 2, the coverage area of the network 200 is organized into location areas 4 (only one of which is shown), each location area 4 typically containing several cells 11, which are the basic unit of division of the coverage area for the purposes of spectrum management and are shown in the figure as idealized hexagons. The cells 11 are grouped into location areas to facilitate routing of a call to the Mobile Station (MS) 13. Each cell 11 contains a Base Station Transceiver (BTS) 15, each of which houses one or multiple radio transceivers for communicating with MSs 13 over the radio “air interface”, and these transceivers are connected via “A-bis” signaling links 17 to a Base Station Controller (BSC) 19 which may control transceivers in more than one BTS 15. The sub-system comprising a BSC 19 and its associated BTSs 15 is sometimes referred to as a Base Station Subsystem (BSS) 35. The BSCs 19 are themselves coordinated via “A” signaling links 21 by Mobile Services Switching Centers (MSCs) 23, which may control BSCs 19 in more than one location area. The MSCs 23 typically contain Visitor Location Registers (VLRs) for coordinating services to MSs 13, and have links 25 carrying Mobile Application Procedure (MAP) messages from the MSCs/VLRs 23 to Signal Transfer Points (STPs) 27 providing signaling connections to other parts of the network such as a Home Location Register (HLR) 29 for storing subscriber information.

In the present method, signaling data which can be used to determine the efficiency of operation of the network is obtained by the use of XID frames for the LAPDm traversing the Um link between the MS 13 and BTS 15 (and therefore the BSS) as encircled 010 in FIG. 2.

Using XID frames, the protocol peers can negotiate the protocol parameters such as the window size. Moreover, this simple handshake enables the peers to have even further negotiation regarding other procedure parameters such as timers and counters. As an option, the network may broadcast its capability of negotiation at the LAPDm layer with a new negotiation mechanism using an XID frame. This can simply be done by adding an information element into the existing system information messages. It should be noted that legacy mobile stations, that do not have the capability to understand a message that contains information elements pertaining to an XID frame, cannot communicate with a BSS using the XID frame.

FIG. 3 is a signal diagram of a link establishment and parameter negotiation between a MS 13 and the Base Station System (BSS 35), in accordance with the present method and shows a two way communication process sometimes known as a handshake process that takes place between a MS (13) and a BSS (35). The protocol parameters, indicated in FIG. 3, refer to any and all LAPDm parameters including but not limited to timers, counters, window size, and the like. Moreover, the negotiation can also be used to exchange the MS advanced capability.

When the MS (13) first accesses the BSS (35) on a signaling link, it is in order to request a kind of service (e.g. registration or a call setup). The requests can be done by a Layer 3 message. A Set Asynchronous Balanced Mode (SABM) command shown by step 310 is sent by the MS to the BSS. The BSS, upon receiving such a message, replies with an unnumbered acknowledgement UA (step 312), thereby completing first part of the handshake. The MS entity then sends to the BSS the XID frame with either of the following protocol parameters: timers, counters, and window size (step 314). The BSS upon receiving the XID procedure completes the negotiation process and acknowledges with the corresponding XID frame (step 316).

Although FIG. 3 shows the negotiation started by the MS, it should be noted that the XID negotiation can also be started by the BSS. It should also be noted that the introduction of XID frames will not have a major impact on the LAPDm protocol. Currently, there are five different frames defined for the Unnumbered “U” format. Exactly what frame type is being sent is always pointed out, by the transmitter, using defined combinations of U-bits in the Control Field. As there are also five bits reserved for this function, theoretically thirty two different types of U-frames may be defined. The five bits are used in order to point out what type of U-frame is being sent (i.e. like a Message Type). The introduction of XID-frame simply needs a new code-point and there are no problems associated with its introduction.

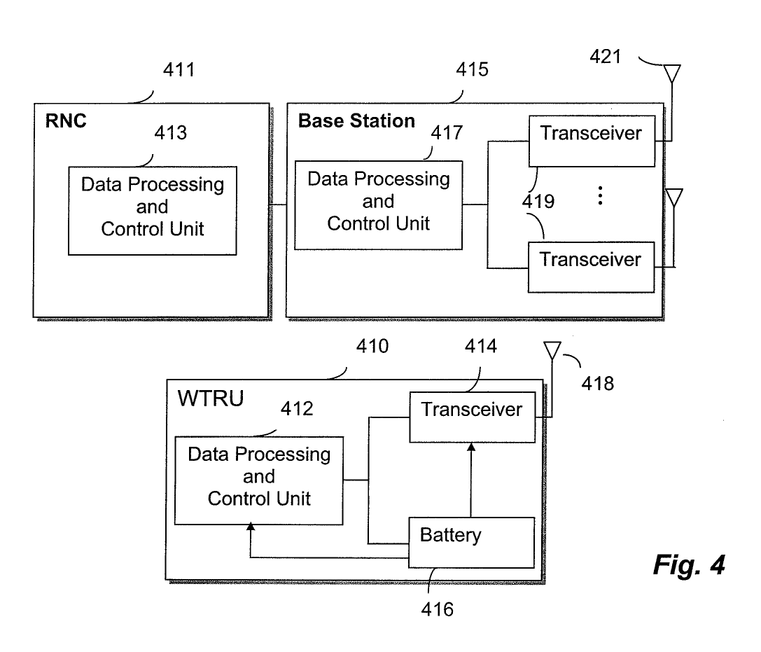

In FIG. 4, a radio network controller (RNC), a base station (BS) or eNB and a WTRU are shown. The RNC 411 and base station 415 shown in FIG. 4 are wireless network nodes that each includes a corresponding data processing and control unit 413 and 417 for performing numerous wireless and data processing operations required to conduct communications between the RNC 411 and the WTRU 410. Part of the equipment controlled by the base station data processing and control unit 417 includes a plurality of wireless transceivers 419 connected to one or more antennas 421. The WTRU 410 shown in FIG. 4 also includes a data processing and control unit 412 for controlling the various operations required by the WTRU. The WTRU's data processing and control unit 412 provides control signals as well as data to a wireless transceiver 414 connected to an antenna 418. Both the data processing and control unit 412 and transceiver 414 are powered from voltage supplied by battery 416.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A wireless transmit/receive unit (WTRU) comprising:
a transceiver configured to transmit a command to initiate a service, receive an acknowledgement response, transmit an exchange information (XID) frame for link access procedure on a Dm (data) channel (LAPDm) including a first set of parameters, and receive an XID frame confirming the first of parameters.

2. The WTRU of claim 1, wherein XID frames include procedure parameters that include at least one of the following: timers, counters, and window size.

3. The WTRU of claim 1, wherein bits are reserved for indicating what frame type is being sent, the maximum number of bits being reserved for indicating what frame type is being sent is five bits.

4. The WTRU of claim 1, wherein the processor indicates what frame type is being sent and uses combinations of U-bits in a control field to indicate what type of frame is being sent.

5. The WTRU of claim 1, wherein a set asynchronous balanced mode (SABM) message is transmitted between the WTRU and a base station system (BSS).

6. The WTRU of claim 1, wherein an unnumbered acknowledge (UA) message is transmitted between the WTRU and a base station system (BSS).

7. The WTRU of claim 1, further comprising modifying the LAPDm procedure for signaling.

8. A base station system (BSS) comprising:
a transceiver configured to transmit a command to initiate a service, receive an acknowledgement response, transmit an exchange information (XID) frame for link access procedure on a Dm (data) channel (LAPDm) including a first set of parameters, and receive an XID frame confirming the first of parameters.

9. The BSS of claim 8, wherein XID frames include procedure parameters that include at least one of the following: timers, counters, and window size.

10. The BSS of claim 8, wherein the negotiation process can be initiated at either by the WTRU or by the BSS.

11. The BSS of claim 8, wherein bits are reserved for indicating what frame type is being sent, the maximum number of bits being reserved for indicating what frame type is being sent is five bits.

12. The BSS of claim 8, wherein the processor indicates what frame type is being sent and uses combinations of U-bits in a control field to indicate what type of frame is being sent.

13. The BSS of claim 8, wherein a set asynchronous balanced mode (SABM) message is transmitted between the WTRU and the BSS.

14. The BSS of claim 8, wherein an unnumbered acknowledge (UA) message is transmitted between a wireless transmit/receive unit (WTRU) and the BSS.

15. The BSS of claim 8, further comprising modifying the LAPDm procedure for signaling.
